(19) United States
(12) Patent Application Publication
(10) Pub. No.: US 2011/0195150 A1
(43) Pub. Date: Aug. 11, 2011

(54) COMPOSITION OF "RADOY" BEER AND ITS PRODUCTION METHOD

(76) Inventor: Yevhen YUKHNYTSYA, (US)

(21) Appl. No.: 12/839,667

(22) Filed: Jul. 20, 2010

(30) Foreign Application Priority Data
Feb. 9, 2010 (UA) A 2010 01355

(51) Int. Cl. C12C 11/00; C12C 11/11; C12C 7/20

(52) U.S. Cl. 426/16; 426/592

(57) ABSTRACT

A beer composition includes water, ground malt, yeast of bottom fermentation, hop extract and milk thistle solution in the following proportion: 100 l water; 10-50 kg ground malt; 1.0-3.0 l yeast of bottom fermentation; 10-30 g of alpha acid of hops extract; 5-30 g milk thistle solution for 1 l of wort. A production method includes mash preparation, mash saccharification, wort separation from the spent grains, wort boiling, fermentation, and afterfermentation. At the beginning of wort boiling the milk thistle is added, whose fruits were ground in a grinder with a roller distance of 0-2.5 mm, the grinding is mixed with water, heated to 70-150° C., and boiled for 45-90 minutes, whereupon milk thistle fruit concentration makes from 1 to 99% of wort volume. The beer composition enables not only a positive effect on a human body, especially on a liver and kidneys, but also having curative properties.

The sphere of invention is the food industry, in particular, beer and its production.

The beer composition that includes a wheaten or a barley malt, hop, water and yeast of top germination [LLC “Breweries Heineken Incorporated”, St.-Petersburg, http://ru.wikipedia.org/wiki/Edelweiss(%D0%BF%D0%B8%D0%B2%D0%BE)].

The aforementioned beer composition has no curative properties.

Production method of a special beer that consists of wort preparation, its boiling with subsequent hopping, cooling to 8-10° C., wort fermentation, cooling of the new beer to 0÷+2° C., maturing, filtration and bottling. Wort boiling when hopping is performed up to the concentration of Gs 1.5-1.7 g/dal and up to the solids concentration of 11%, fermentation is carried out within 10-14 days prior to alcohol accumulation of 8.0-8.5% vol. For this purpose during the first five days maltose or maltose treacle is added in a quantity that provides solids concentration no more than 11%, new beer maturing is performed within 10-14 days with subsequent mixing of beer with preliminary prepared water up to the alcohol concentration of 5.0-7.0% vol., in such a case, preliminary water preparation is carried out by deaeration up to the oxygen concentration no more than 0.1 mg/l, carbonation up to the carbon dioxide concentration no less than 0.3%, sterilization, cooling to 0÷−1° C., pH normalization and salts concentration normalization [RU No. 2373269, C12C12/00 2009].

The closest to the invention claimed is the beer production method that includes mash preparation, mash saccharification, wort separation from a spent grains, wort boiling with hop, fermentation, afterfermentation, filtration, saturant gas introduction (xenon or gas mix containing xenon) up to reaching an equilibrium state of gas-liquid and finished product bottling under the overpressure [RU No. 2333945, C12C 5/00, 2007].

The beer produced using the specified method, as well as the previous one, has no curative properties.

The invention is based on the task to invent beer by composition changes that would have not only positive effect on a human body, especially on liver and kidneys, but would have curative properties.

The second task assumed as a basis of the invention is to invent such method that would enable to produce beer that would have not only positive effect on a human body, especially on liver and kidneys, but would have curative properties, by means of introduction of an additional product.

The task set can be accomplished by adding, according to the invention, ground malt, yeast of bottom fermentation, hop extract and additionally the milk thistle solution to the beer composition (that includes water, malt, yeast, hop) with a following components proportion:

Water 100 l

Ground malt 10-50 kg

Yeast of bottom fermentation 1.0-3.0 l

Hop extract 10-30 g of alpha acid

Milk thistle solution 5-30 g for 1 l of wort.

The second task assumed as a basis of the invention can be accomplished by adding to the beer production method (that includes mash preparation, mash saccharification, wort separation from a spent grains, wort boiling, fermentation, afterfermentation), according to the invention, the milk thistle at the beginning of boiling, which fruits are preliminary ground in a grinder where the distance between rollers is from 0 to 2.5 mm, a grinding is mixed with water, heated to the temperature of 70-150° C., and boiled for 45-90 minutes, whereupon milk thistle fruits concentration makes from 1 to 99% of wort volume.

For a mash preparation at first malt is ground in the grinders, then the ground malt is added into a mashing apparatus where it is mixed with water, preliminary heated to 55-63° C., to produce extract, mash temperature is raised to 62-64° C. within 4 minutes, holding it at this temperature for 15-45 minutes, then the mash temperature is raised to 70-72° C., holding it at this temperature for 10-30 minutes, the saccharification is performed for 18 minutes and the mash temperature is raised to 75-78° C., holding it at this temperature for 2-8 minutes.

After wort boiling it is settled in “Whirlpool” apparatus, pumped to fermentation tanks and afterfermented with simultaneous cooling and yeast adding, then self-fermentation and afterfermentation take place.

Adding milk thistle at the beginning of wort boiling, which fruits are preliminary ground in a grinder where the distance between rollers is from 0 to 2.5 mm, the grinding is mixed with water, heated to the temperature of 70-150° C. and boiled for 45-90 minutes, and milk thistle fruits concentration makes from 1 to 99% of wort volume, enables to produce beer having not only positive effect on a human body, especially on liver and kidneys, but also having curative properties.

The milk thistle is the plant having important medical properties. Milk thistle seeds contain over a hundred vitamins and microelements beneficial for humans. Silymarin is particularly valuable. This substance restores organism cells and intensifies their protective properties. Milk thistle is not usually used in its pure form. Oil and different medical products can be produced from its seeds.

“RADOY” beer is produced as follows.

“RADOY” beer production method is carried out as follows.

First, malt is ground in grinders, then the ground malt is added into the mashing apparatus where it is mixed with water, preliminary heated to 55-63° C., for producing the extract, mash temperature is raised to 62-64° C. within 4 minutes, holding it at this temperature for 15-45 minutes, then mash temperature is raised to 70-72° C., holding it at this temperature for 10-30 minutes, the saccharification is performed for 18 minutes and temperature is raised to 75-78° C., holding it at this temperature for 2-8 minutes.

The produced mash is pumped to the filter apparatus where the solution is separated from the spent grains. For this purpose water, which washes an extract away from the spent grains, is used. The solution that contains soluble components of malt is called the wort. Spent grains are discharged from the filter apparatus and can be used for animals' feeding. Filtered wort is delivered to the wort boiler. The grinding is separated from water and is added to wort at the beginning of boiling. Simultaneously milk thistle is added which fruits are preliminary ground in grinder where the distance between rollers is from 0 to 2.5 mm, a grinding is mixed with water, heated to the temperature of 70-150° C. and boiled for 45-90 minutes. Milk thistle fruits concentration makes from 1 to 99% of wort volume.

After wort boiling it is settled in “Whirlpool” apparatus, pumped to fermentation tanks and afterfermented with simultaneous cooling and yeast adding, then fermentation and afterfermentation take place.

The invention is illustrated by an example.

“RADOY” beer composition:

Water—100 l

Ground malt—30 kg

Yeast of bottom fermentation—1.6 l

Hop extract—16.5 g of alpha acid

Milk thistle solution—15 l for 161 l of wort.

The taste of beer produced—with a medium bitterness and a hint of milk thistle.

Physical and chemical characteristics are given in the table.

| JrTotal | Unit | Value |
|---|---|---|
| Carbon dioxide | Wt % | 0.4-0.52 |
| Extract, external | Wt % | 2.53-2.75 |
| Extract, true | Wt % | 4.2-4.57 |
| Alcohol Wt % | Wt %, not less than | 3.45 |
| Alcohol % vol. | % vol., not less than | 4.4 |
| Basic wort extract | Wt % | 11.21-12.21 |
| Fermentation degree, true | % vol./Wt % | 63.95 |
| Fermentation degree, external | % vol./Wt % | 77.43 |
| Extract, external, fermented | Wt % | 2.6 |
| After fermentation degree | % vol./Wt % | 77.5 |
| Mass fraction of total nitrogen | mg/kg | 649 |
| Total protein | g/100 ml | 0.41 |
| Total polyphenols | mg/kg | 193 |
| Bitterness unit | | 10-20 |
| pH level | | 4.01-4.64 |
| Colour | EBK | 4.4-8.4 |
| Foam stability (HLT) | HLT | 95 |
| Foam stability (SKZ) | SKZ | 114 |
| Density | 20/4° C. | 1.00850 |

1. A beer composition comprising water, malt, yeast, hops ground malt, yeast of bottom fermentation, hops extract, and a milk thistle solution;
wherein the water, the ground malt, the yeast of bottom fermentation, the hops extract, and the milk thistle solution are provided proportionally as follows:
Water 100 l
Ground malt 10-50 kg
Yeast of bottom fermentation 1.0-3.0 l
Hops extract 10-30 g of alpha acid
Milk thistle solution 5-30 g for 1 l of wort.

2. A beer production method comprising steps of:
mash preparation;
mash saccharification;
wort separation from the spent grains;
wort boiling;
fermentation; and
afterfermentation;
wherein the method further comprises adding milk thistle at the beginning of boiling step, fruits of the milk thistle having been ground in a grinder, wherein the distance between rollers of the grinder is from 0 to 2.5 mm, the grinding being mixed with water, heated to a temperature of 70-150° C., and boiled for 45-90 minutes, whereupon a concentration of the milk thistle fruits makes from 1 to 99% of the wort volume.

3. The method according to claim 2, wherein the mash preparation step further includes:
grinding the malt in grinders;
adding the ground malt into the mashing apparatus where the ground malt is mixed with water;
preliminary heating the ground malt and water mixture to 55-63° C., to produce extract;
raising the mash temperature to 62-64° C. within 4 minutes, then holding it at this temperature for 15-45 minutes;
raising the mash temperature to 70-72° C., then holding it at this temperature for 10-30 minutes;
performing the saccharification is performed for 18 minutes; and
raising the temperature to 75-78° C., then holding at this temperature for 2-8 minutes.

4. The method according to claim 2, wherein after wort boiling the wort is settled in a “Whirlpool” apparatus, pumped to fermentation tanks and afterfermented with simultaneous cooling and yeast addition, followed by fermentation and afterfermentation.
